(19) United States
(12) Patent Application Publication
(10) Pub. No.: US 2004/0066391 A1
(43) Pub. Date: Apr. 8, 2004

(54) Method and apparatus for static image enhancement

(76) Inventors: Mike Daily, Thousand Oaks, CA (US); Kevin Martin, Oak Park, CA (US)

Correspondence Address: TOPE-MCKAY & ASSOCIATES, 23852 PACIFIC COAST HIGHWAY #311, MALIBU, CA, 90265, US

(21) Appl. No.: 10/264,091

(22) Filed: Oct. 2, 2002

(51) Int. Cl. G09G 5/00

(52) U.S. Cl. 345/629

(57) ABSTRACT

The present invention relates to a method and apparatus for augmenting static images including a data collection element 100, an augmenting element 102, an image source 104, and a database 106. The data collection element 100 collects data regarding the circumstances under which a static image is collected and provides the data to an augmenting element 102. The image source 104 provides at least one static image to the augmenting element 102. Once the augmenting element 102 has both the static image and the collected data, the augmenting element utilizes the database 106 as a source of augmenting data. The retrieved augmenting data are then overlaid onto the static image, or are placed onto a margin of the static image, such that the augmenting data are identified with certain elements of the static image.

### TECHNICAL FIELD

The present invention is generally related to image enhancement and more specifically to a method and apparatus for static image enhancement.

### BACKGROUND

There is currently no automatic, widely accessible means for a static image to be enhanced with content related to the location and subject matter of a scene. Further, conventional cameras do no not provide a means for collecting position data, orientation data, or camera parameters. Nor do conventional cameras provide a means by which a small number of landmarks with known position in the image can serve as the basis for additional image augmentation. Static images, such as those created by photographic means, provide records of important events, historically significant landmarks, or information that are otherwise meaningful to the photographer. Because of the high number of images collected, it is often impractical for the photographer to augment photographs by existing methods. Further, the photographer will periodically forget where the picture was taken, or will forget other data relative to the circumstances under which the picture was taken. In these cases, the picture cannot be augmented by the photographer because the photographer does not know where to seek the augmenting information. Therefore a need exists in the art for a means for augmenting static images, wherein such a means could utilize a provided static image, data collected by a data collection element, and data provided by a database, to produce an augmented static image.

### SUMMARY OF THE INVENTION

The present invention provides a means for augmenting static images, wherein the means utilizes a static image, data collected by a data collection element, and data provided by a database, to produce an augmented static image.

One aspect of the present invention provides an apparatus for augmenting static images. The apparatus includes a data collection element configured to collect data, an augmenting element configured to receive collected data, an image source configured to provide at least one static image to the augmenting element, and a database configured to provide data to the augmenting element. The augmenting element utilizes the static image, the data collected by the data collection element, and the data provided by the database, to produce an augmented static image.

Another aspect of the present invention provides a method for augmenting static images comprising a data collection step, a database-matching step, an image collection step, an image augmentation step, and an augmented-image output step. The data collection step collects geospatial data regarding the circumstances under which a static image was collected and provides the data to the database matching step. In this step relevant data are matched and extracted from the database, and relevant data are provided to an augmenting element. The image collected in the image collection step is provided to the augmenting element; and when the augmenting element has both the static image and the extracted data, the augmenting element performs the image augmentation step, and ultimately provides an augmented static image to the augmented image output step.

In yet another aspect of the present invention the data collection element could receive input from a plurality of sources including a Global Positioning System (GPS), or satellite based positioning system, a tilt sensing element, a compass, a radio direction finder, and an external user interface configured to receive user input. The user-supplied input could include user-identified landmarks, user-provided position information, user-provided orientation information, and image source parameters. Additionally, this user-supplied input could select location or orientation information from a database. The database could be a local, user-created, or non-local database, or a distributed database such as the Internet.

### BRIEF DESCRIPTION OF THE DRAWINGS

The objects, features, and advantages of the present invention will be apparent from the following detailed description of the preferred aspect of the invention with references to the following drawings.

FIG. 1 is a block diagram depicting an image augmentation apparatus according to the present invention;

FIG. 2 is a block diagram depicting an image augmentation method according to the present invention;

FIG. 3 is an illustration of a camera equipped with geospatial data recording elements; and

FIG. 4 is a block diagram showing how various elements of the present invention interrelate to produce an augmented image.

### DETAILED DESCRIPTION

The present invention provides a method and apparatus for static image enhancement.

The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore, it should be noted that, unless explicitly stated otherwise, the figures included herein are illustrated diagrammatically and without any specific scale, as they are provided as qualitative illustrations of the concept of the present invention.

Glossary

Augment or Augmentation—Augmentation is understood to include both textual augmentation and visual augmentation. Thus, an image could be augmented with text describing elements within a scene, the scene in general, or other textual enhancements. Additionally, the image could be augmented with visual data.

Database—The term “database,” as used here is consistent with commonly accepted usage, and is also is understood to include distributed databases, such as the Internet. Additionally the term “distributed database” is understood to include any database where data is not stored in a single location.

Data collection element—This term is used herein to indicate an element configured to collect geospatial data. This element could include a GPS unit, a tilt sensing element, a radio direction finder element, and a compass. Additionally, the data collection element could be a user interface configured to accept input from a user, or other external source.

Geospatial data—The term “geospatial data,” as used herein includes at least one of the following: data relating to an image source's angle of inclination or declination (tilt), a direction that the image source is pointing, the coordinate position of the image source, the relative position of the object, and the altitude of the image source. Coordinate position might be determined from a GPS unit, and relative position might be determined by consulting a plurality of landmarks. Further geospatial data may include image source parameters.

Image Source—The term “image source” includes a conventional film camera or a digital camera, or other means by which static images are fixed in a tangible medium of expression. The image, from whatever source, must be in a form that can be digitized.

Image Source Parameters—This term, as used herein, includes operating parameters of a static image capture device, such as the static image capture device's focal length and field of view.

Introduction

The present invention provides a method and apparatus for static image enhancement. In one aspect of the present invention, a static image is recorded, and data concerning the circumstances under which the image was collected are also recorded. The combination of the static image and the data concerning the circumstances under which the data were collected are submitted to an image-augmenting element. The image-augmenting element uses the provided data to locate and retrieve geospatial data that are relevant to the static image. The retrieved geospatial data are then overlaid onto the static image, or are placed onto a margin of the static image, such that the geospatial data are identified with certain elements of the static image.

Apparatus

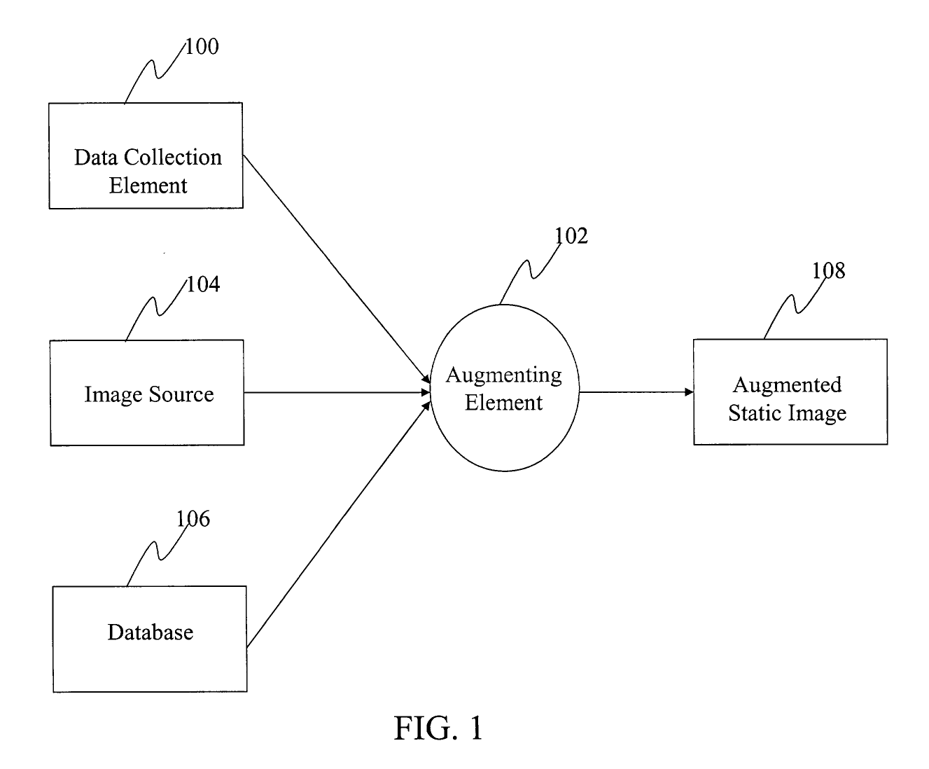

One aspect of the present invention includes an apparatus for augmenting static images. The apparatus, according to this aspect, is elucidated more fully with reference to the block diagram of FIG. 1. This aspect includes a data collection element 100, an augmenting element 102, an image source 104, and a database 106. The components of this aspect interact in the following manner: The data collection element 100 is configured to collect data regarding the circumstances under which a static image is collected. The data collection element 100 then provides the collected data to an augmenting element 102, which is configured to receive collected data. The image source 104 provides at least one static image to the augmenting element 102. Once the augmenting element 102 has both the static image and the collected data, the augmenting element 102 utilizes the database 106 as a source of augmenting data. The retrieved augmenting data, which could include geospatial data, are then fused with the static image, or are placed onto a margin of the static image, such that the augmenting data are identified with certain elements of the static image and an augmented static image 108 is produced.

Method

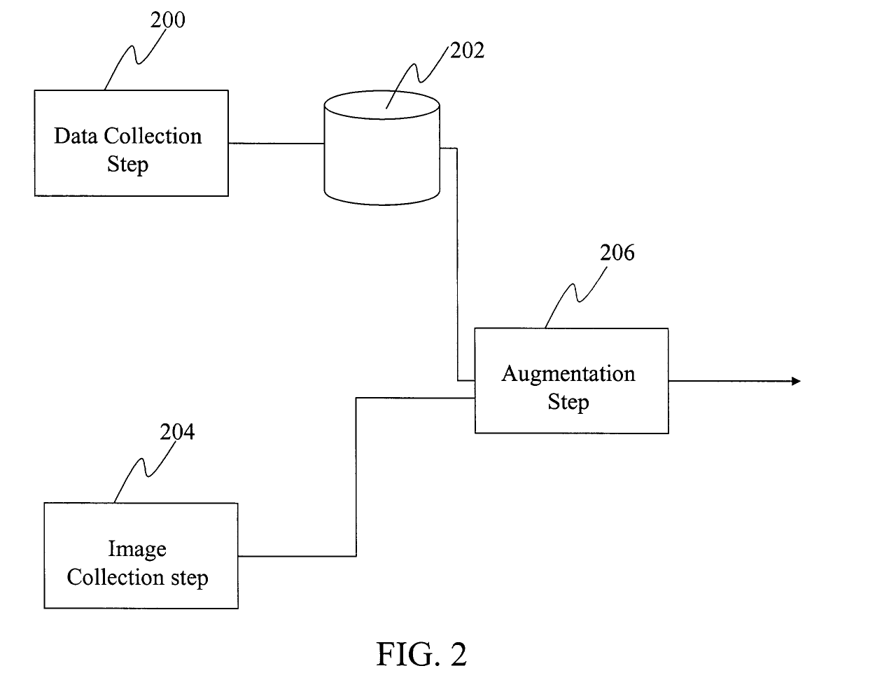

Another aspect of the present invention includes a method for augmenting static images. The method, according to this aspect, is elucidated more fully in the block diagram of FIG. 2. This aspect includes a data collecting step 200, a database-matching step 202, an image collecting step 204, an image augmenting step 206, and an augmented-image output step. The steps of this aspect sequence in the following manner: The data collecting step 200 collects geospatial data regarding the circumstances under which a static image is collected and provides the data for use in a database matching step 202. During the database matching step 202, relevant data are matched and extracted from the database and are provided to an augmenting element. The image collected in the image collecting step 204 is provided to the augmenting element. Once the augmenting element has both the static image and the extracted data, the augmenting element performs the image augmenting step 206. The augmentation can be directly layered onto the image, or placed onto a margin of the static image, such that the augmenting data are identified with certain elements of the static image. Finally the augmenting element provides an augmented static image to the augmented image output step.

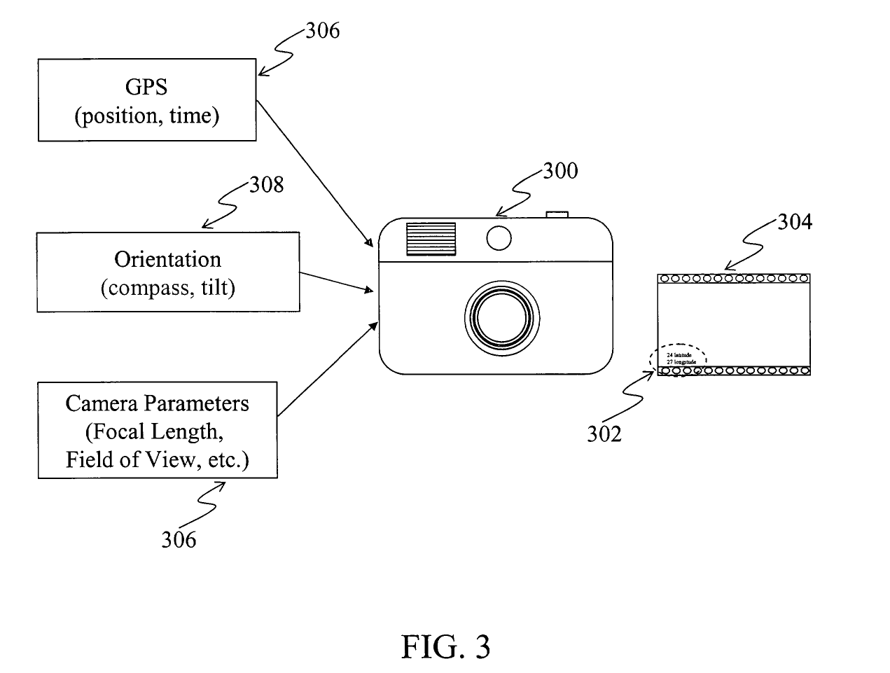

Another aspect of the present invention is presented in FIG. 3. An image is captured with a camera 300, or other image-recording device. The camera 300, at the time the image is captured, stamps the image with geospatial data 302. The encoded geospatial data 302 could be part of a digital image or included on the film negative 304. Stenographic techniques could also be used to invisibly encode the geospatial data into the viewable image. See U.S. Pat. No. 5,822,436, which is incorporated herein by reference. Any image data that is not provided with the image could be provided separately. Thus, the camera might be equipped with a GPS 306, sensor which could be configured to provide position and time data, and a compass element 308, configured to provide direction and, in conjunction with a tilt sensor, the angle of inclination or declination. Additional data regarding camera parameters 310, such as the focal length, and field of view can be provided by the camera. Further, a user might input other information.

If the camera does not record any information, or records inadequate information, a user may supply additional information related to the landmarks found in the photo. In this way it may be possible to ascertain the position and orientation of the camera. In the event that insufficient geospatial data is recorded regarding the position of the photographer, a user may still augment the image. In such a situation the user may take part in an interactive session with a database. During this session the user might identify known landmarks. Such a session presents a user with a list of locations through either a map or a text list. In this way a user could specify the region where the image was captured. The database, optionally, could present a list of landmark choices available for that region. The user might then select a landmark from the list, and thereafter select one or more additional landmarks. Information in the geospatial database could be stored in a format that allows queries based on location. Further, the database can be local, non-local and proprietary, non-local, or distributed, or a combination of these. One example of a distributed database could be the Internet, a local database could be a database that has been created by the user. Such a user created database might be configured to add augmenting data regarding the identities of such things as photographed individuals, pets, or the genus of plants or animals.

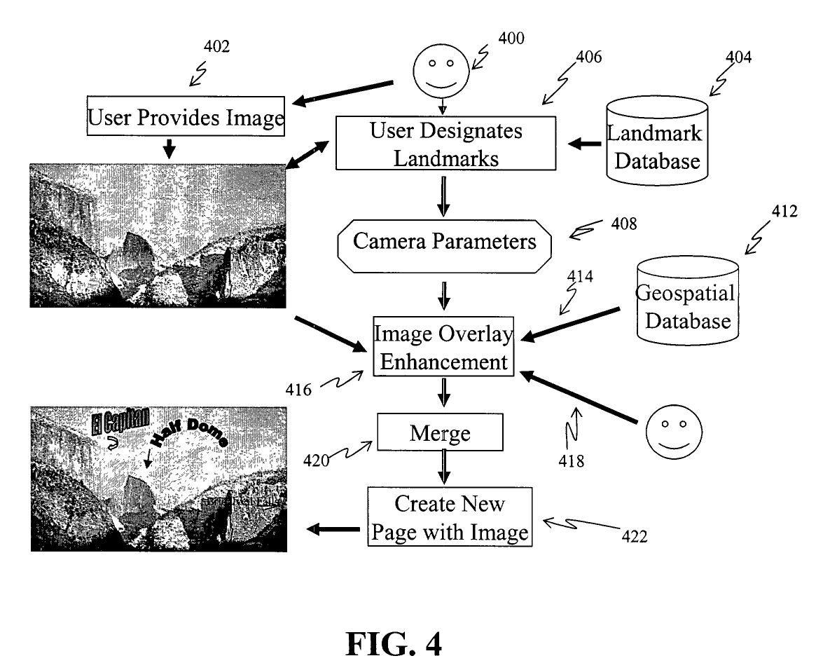

Another aspect of the present invention is depicted in FIG. 4. A user 400 provides an image 402 to static image enhancement system. A landmark database 404 provides a list of possible landmarks to the user 400. The user 400 designates landmarks 406 on the image, from these landmark designations and from available camera parameters 408, the position, orientation, and focal length are determined. A geospatial database 412 is queried and geospatial data 414 is provided to produce an image overlay enhancement 416 based on user preferences 418. The image overlay enhancement 416 is merged 420 with the original user provided image 402 to provide a geospatially enhanced image 422.

In another aspect, a user may select the type of overlay desired. Once the type of overlay is selected, the aspect queries the database for all the information of that particular type which is within the field of view of the camera image. The image overlay enhancement may need to perform a de-cluttering operation of the augmentation results. This would likely occur in situations where significant overlays are selected. The resulting overlay is then merged back into the standard image format of the original image and would be made available to the user. In an alternative aspect, the augmenting data is placed on the border of the image or on a similarly appended space.

The apparatus of the present invention provides geospatial data of the requisite accuracy for database based augmentation. Such accuracy is well within the parameters of most camera systems and current sensor technology. Consider the 35 mm format and common focal lengths of lenses. When equipped with a nominal 50 mm focal length lens, the diagonal field of view is 46 degrees.

W: Width of film negative

H: Height of film negative

D: Diagonal of film negative in millimeters=\sqrt{H²+W²}

L: Focal Length of camera lens in millimeters.

a. DFOV: Diagonal field of view=2*arctan(D/2/L)

b. HFOV: Horizontal field of view=2*arctan(W/2/L)

c. VFOV: Vertical field of view=2*arctan(H/2/L)

A 35 mm camera produces a negative having a Height=24 mm and Width=36 mm. In this case the image diagonal length D=sqrt(24²+36²) is approximately 43 mm. When using a nominal focal length lens of L=50 mm, the diagonal field of view, typically stated and advertised as the lens field of view, is 2*arctan((43/2)/50) or approximately 46 degrees. The horizontal field of view HFOV=2*arctan((36/2)/50) is approximately 40 degrees. The vertical field of view VFOV=2*arctan((24/2)/50)=27. Other fields of view (FOV) for typical focal length lens are as follows:

| | Diagonal | Horiz. | Vert. | |
|---|---|---|---|---|
| Length (mm) | FOV | FOV | FOV | Pixel FOV at 1000 × 667 |
| 21 | 95 | 84 | 62 | 0.08 |
| 35 | 63 | 54 | 38 | 0.05 |
| 50 | 47 | 40 | 27 | 0.04 |
| 80 | 30 | 25 | 17 | 0.03 |
| 100 | 24 | 20 | 14 | 0.02 |
| 200 | 12 | 12 | 7 | 0.01 |

Current digital magnetic compasses and tilt sensors have accuracies on the order of 0.1 to 0.5 degrees. Utilizing a 50 mm lens, this size of angular error provides an accuracy for placing a notation in the range from 0.1/0.04=2.5 pixels to 0.5/0.04=12.5 pixels.

Current non-differential GPS sensors have an accuracy on the order of about 50-100 meters. Better systems operate with better accuracy. With any lens, sensor translational errors will be more apparent with near field objects. As an example, consider an image captured with a 50 mm lens, digitized to 1000 horizontal pixels. The angular pixel coverage is 0.04 degrees. At 100 meters from the camera, a pixel represents 100*tan(0.04 degrees)=0.070 m/pixel. A translational error of 50 meters orthogonal to the pointing vector of the field of view at this range would be 50/0.070=714 pixels, clearly providing insufficient accuracy for annotating near field objects. At 10,000 m from the camera, a pixel represents 10,000*tan(0.04 degrees)=7.00 m. A similar translational error of 50 meters in this case would only result in 50/7=7.1 pixels, which would be suitable for annotation purposes. It is therefore anticipated that photos taken of objects that are near the camera will use an augmented GPS, or a radio triangulation system. Such a triangulation system could use a cellular network, or other broadcasting tower system to accurately provide geographic coordinates.

What is claimed is:

1. An apparatus for augmenting static images comprising:
a. an image source configured to provide at least one static image;
b. a geospatial data collection element configured to collect geospatial data relevant to the at least one static image;
c. a database configured to provide information relevant to the at least one static image; and
d. an augmenting element communicatively connected with the image source, the geospatial data collection element, and the database to receive the static image, the geospatial data, and the information therefrom and to fuse the static image with the information to generate an augmented image.

2. An apparatus for augmenting static images as set forth in claim 1, wherein the data collection element includes at least one of the following:
a. a global positioning system;
b. a tilt sensor;
c. a compass;
d. a user interface configured to receive user input; and
e. a radio direction finder.

3. An apparatus for augmenting static images as set forth in claim 1, wherein the data collection element includes a user interface wherein the interface is configured to receive input related to at least one of the following:
a. user identified landmarks;
b. user provided position information;
c. user provided orientation information; and
d. user provided image source parameters.

4. An apparatus for augmenting static images as set forth in claim 1, wherein collected geospatial data is recorded by at least one of the following means:
a. data is encoded in the image; and
b. data is recorded on the image.

5. An apparatus for augmenting static images as set forth in claim 1, wherein the database is selected from a list comprising:
a. non-local proprietary database;
b. a local, user-created database; and
c. a distributed database.

6. An apparatus for augmenting static images as set forth in claim 1, wherein the database is the Internet.

7. An apparatus for augmenting static images as set forth in claim 1, wherein a user engages in an interactive session with the database, and wherein the user identifies landmarks known to the user.

8. An apparatus for augmenting static images as set forth in claim 7, wherein said session presents the user with a list of locations through at least one of the following:
a. a map; and
b. a text based list.

9. An apparatus for augmenting static images as set forth in claim 8, wherein the database presents a text based list of regional landmark choices, and prompts the user to select a landmark from the text based list.

10. An apparatus for augmenting static images comprising:
a. an image source configured to provide at least one static image;
b. a geospatial data collection element configured to collect geospatial data relevant to the at least one static image;
c. a connection to a database, wherein the database is configured to provide information relevant to the at least one static image; and
d. an augmenting element communicatively connected with the image source, the geospatial data collection element, and the database to receive the static image, the geospatial data, and the information therefrom and to fuse the static image with the information to generate an augmented image.

11. A method for augmenting static images comprising the steps of:
receiving at least one static image from an image source;
receiving geospatial data relevant to the at least one static image;
collecting information relevant to the static image in a processing device; and
augmenting the static image by fusing the information with the static image to generate an augmented image.

12. A method for augmenting static images as set forth in claim 11 wherein the step of receiving geospatial data includes receiving geospatial data from at least one of the following:
a. a global positioning system;
b. a tilt sensor;
c. a compass;
d. a user interface configured to receive user input; and
e. a radio direction finder.

13. A method for augmenting static images as set forth in claim 11 wherein the step of receiving information relevant to the static image includes receiving geospatial data from at least one of the following:
a. user identified landmarks;
b. user provided position information;
c. user provided orientation information; and
d. user provided image source parameters.

14. A method for augmenting static images as set forth in claim 11, wherein received geospatial data is recorded by at least one of the following means:
a. data is encoded in the image; and
b. data is recorded on the image.

15. An method for augmenting static images as set forth in claim 11, wherein the collected information is collected from at least one of the following:
a. non-local proprietary database;
b. a local, user created, database; and
c. a distributed database.

16. A method for augmenting static images as set forth in claim 11, wherein the collected information is collected from the Internet.

17. A method for augmenting static images as set forth in claim 11, wherein a user engages in an interactive session with a database, and wherein the user identifies landmarks known to the user.

18. A method for augmenting static images as set forth in claim 17, wherein said session presents the user with a list of locations through at least one of the following:
a. a map; and
b. a text based list.

19. A method for augmenting static images as set forth in claim 18, wherein the database presents a text based list of regional landmark choices, and prompts the user to select a landmark from the text based list.
